(19) United States
(12) Patent Application Publication
(10) Pub. No.: US 2004/0137909 A1
(43) Pub. Date: Jul. 15, 2004

(54) Capacity adaptive technique for distributed wireless base stations

(76) Inventors: Marios Gerogiokas, Sparta, NJ (US); Vladimir Levitine, Mountainside, NJ (US); Manouchehr Niknam, Sparta, NJ (US); Ralph Walk, Madison, NJ (US)

Correspondence Address: GREENBERG TRAURIG, LLP, 885 Third Avenue, New York, NY, 10022, US

(21) Appl. No.: 10/303,428

(22) Filed: Nov. 25, 2002

(51) Int. Cl. H04Q 7/20

(52) U.S. Cl. 455/453

(57) ABSTRACT

A radio transmission system and method routes incoming user signals to at least one radio equipment that is eligible to handle the user signal. The average user population and rate of change of user population for each radio equipment are calculated by control circuitry monitoring a plurality of radio equipment. A ceiling threshold and user population threshold are initially established for each of the radio equipment. As users are admitted to the system, incoming user signals are routed to a radio equipment selected from eligible radio equipment. The radio equipment deemed eligible are those which have current user population below their population thresholds and population thresholds adequately below their ceiling thresholds. Incoming user signals are routed to at least one selected radio equipment based on the average user population and rate of change of user population of the radio equipment of the system. The population thresholds of the radio equipment are updated after incoming user signals have been routed to at least one radio equipment.

### BACKGROUND OF THE INVENTION

1. Field of the Invention

The present invention generally relates to communication systems and in particular to wireless communication systems.

2. Description of the Related Art

One of the more important aspects of a wireless communication system is that system's ability to use its resources in an efficient manner. Therefore, an important objective of a service provider is to satisfy the demands of users of the communication system while using the resources of the system in an efficient manner. A service provider is an entity that owns, operates and maintains the system resources. One of the key demands made on a communication system is the capacity demands by users which have steadily increased in the past few years due to the popularity of wireless devices such as cellular phones, pagers and wireless laptops. Users are individuals or other entities that subscribe to the communication system and use wireless devices to communicate with other users or entities. The capacity of a cellular wireless communication system can be defined as the total number of users that can be simultaneously serviced by the cells of the system to allow such users to convey (i.e., transmit and/or receive) information adequately. The resources are the various equipment and capabilities of the system. Resources include radio equipment for transmitting and receiving communication signals, the amount of bandwidth allocated to the system, the amount of information each cell or portion of cells (i.e., sectors) are allowed to convey and the amount of power allocated to the radio systems. A radio system comprises equipment such as amplifiers, filters, modulators, transmitters, receivers and various signal and information processing equipment. Hereinafter, the terms radio or radio equipment will be used interchangeably with the term radio system. A cell is a defined geographical area which is served by system equipment (equipment owned and controlled by a service provider) typically called a base station. A typical symbolic representation of a cell is a geographic area having the geometry of a hexagon. Further, a cell is typically divided into three sectors where each sector is the area defined by a 120° slice of the hexagon. Sometimes, the sectors are further divided into sub-sectors; for example a 120° sector can be divided into four 30° sub-sectors. There are radio equipment (transmission and reception) assigned to each of the three sectors. The number of users being serviced in each sector is typically directly proportional to any one or a combination of particular resources such as the amount of power allocated to that sector, the amount of bandwidth allocated to that sector or the maximum information rate that can be handled by that sector.

The number of users serviced by the cell depends on the user population of each sector of that cell. A cell services a user by allowing signals from that user to be transmitted and/or received by its radio equipment. Typically, the amount of power used by a cell's radio equipment to transmit user signals is proportional to the population of that cell; that is, the cell population is the total number of users being serviced at a particular time instant. There may be circumstances where a first sector has reached or is near its capacity while a second neighboring sector is not at all near its capacity. A cell capacity is a specific population value above which the cell's radio equipment is not able to adequately service its admitted users. An admitted user is a user that is being serviced or is about to be serviced. Any additional users requesting admission (i.e., requesting service) to the first sector may be refused because that sector simply cannot accommodate additional users. As a result, the resources of the cell are being used inefficiently. The cause of the inefficiency is the fixed assignment of certain radio equipment to each sector of the cell. The radio equipment assigned to the second sector can only service those users requesting admission to that sector. Users requesting admission to the first sector cannot be served by radio equipment assigned to the second sector even though the second sector could easily accommodate such users. In an attempt to resolve this inefficiency problem, service providers have conducted statistical studies of cells within their communication systems so as to allocate the proper amount of radio resources to the cells at the proper time. Therefore, different amounts of radio resources may be allocated to cells depending on the location of the cell, the particular day of the week and the time of day. However, the results of the statistical analysis provide only a likelihood of a particular user demand. The actual user demand on any particular day may deviate substantially from the results of the statistical study. Moreover, the statistical analysis is both costly and lengthy. The analysis may have to be done over a period of weeks or months for all or at least some of the cells in order to properly discern any pattern of user demand on a system level. Additionally, even if the results of the statistical analysis are reasonably reliable, additional statistical studies would have to be done as the amount of users to the system changes or the demographics of the areas covered by the system changes. As a result, additional statistical studies would have to be done. What is therefore needed is a method for efficiently using radio equipment of a wireless communication system without having to rely on lengthy and costly statistical studies.

### SUMMARY OF THE INVENTION

The present invention provides a method and system that allow efficient use of radio equipment of a wireless communication system. The radio equipment of a cell of the communication system is made part of a system architecture that allows any radio equipment of the cell to be able to service any user requesting admission to that cell. The user can be located within any sector or sub-sector of the cell and such user is serviced by the radio equipment that is capable of servicing the requesting user. Thus, when a user requests admission to the communication, that user's signals is routed to the radio most capable of handling the user, viz., the radio equipment whose user population will not be inadequately near its capacity after that user is admitted.

In particular, the method and system of the present invention first establishes an initial population threshold for each of the radio equipment assigned to the cell. The population threshold is set at a value that is below the capacity of the radio equipment. The method and system of the present invention then monitors the user population of each of the radio equipment and calculates an average user population for each such equipment. The rate of change of the user population for each radio equipment is also calculated; such rate of change is the change in user population over a certain defined time period that is directly related to the amount of time it takes to route an incoming signal to a radio equipment and transmit that signal. A weighting coefficient proportional to the calculated rate of change is also calculated. Incoming users are routed to a radio equipment based on that radio equipment's calculated user population and rate of change of user population. As users are admitted or terminated from a radio equipment, the rate of change of user population varies accordingly. An updated threshold based on the weighting coefficient and the current threshold is calculated. Therefore, as the user population varies, the threshold varies in accordance to the rate of change of the user population. Preferably, each of the radio equipment is operated at a threshold that is adequately below the capacity for that radio equipment. When a threshold of a radio equipment is not adequately below its capacity, incoming users are not routed to that radio equipment until its population threshold is below its capacity by a certain number of users; this certain number of users is defined by the service provider or can be calculated with the use of an algorithm.

### BRIEF DESCRIPTION OF THE DRAWINGS

FIG. 1 depicts the architecture of a radio system comprising radio equipment that is used to implement the system and method of the present invention.

FIG. 2 shows a symbolic representation of a cell divides into three sectors each of which is further divided into four sub-sectors.

FIG. 3 is a flow chart of the method of the present invention.

### DETAILED DESCRIPTION

The present invention provides a method and system that allow efficient use of radio equipment of a wireless communication system. The radio equipment of a cell of the communication system is made part of a system architecture that allows any radio equipment of the cell to be able to service any user requesting admission to that cell. The user can be located within any sector or sub-sector of the cell and such user is serviced by the radio equipment that is capable of servicing the requesting user. Thus, when a user requests admission to the communication, that user's signals is routed to the radio most capable of handling the user, viz., the radio equipment whose user population will not be inadequately near its capacity after that user is admitted.

In particular, the method and system of the present invention first establishes an initial population threshold for each of the radio equipment assigned to the cell. The population threshold is set at a value that is below the capacity of the radio equipment. The method and system of the present invention then monitors the user population of each of the radio equipment and calculates an average user population for each such equipment. The user population of a radio equipment is the number of users being serviced by the radio equipment. The rate of change of the user population for each radio equipment is also calculated; such rate of change is the change in user population over a certain defined time period that is directly related to the amount of time it takes to route an incoming signal to a radio equipment and transmit that signal. A weighting coefficient proportional to the calculated rate of change is also calculated. Incoming users are routed to a radio equipment based on that radio equipment's calculated user population and rate of change of user population. As users are admitted or terminated from a radio equipment, the rate of change of user population varies accordingly. An updated threshold based on the weighting coefficient and the current threshold is calculated. Therefore, as the user population varies, the threshold varies in accordance to the rate of change of the user population. Preferably, each of the radio equipment is operated at a threshold that is adequately below the capacity for that radio equipment. When a threshold of a radio equipment is not adequately below its capacity, incoming users are not routed to that radio equipment until its population threshold is below its capacity by a certain number of users; this certain number of users is defined by the service provider or can be calculated with the use of an algorithm.

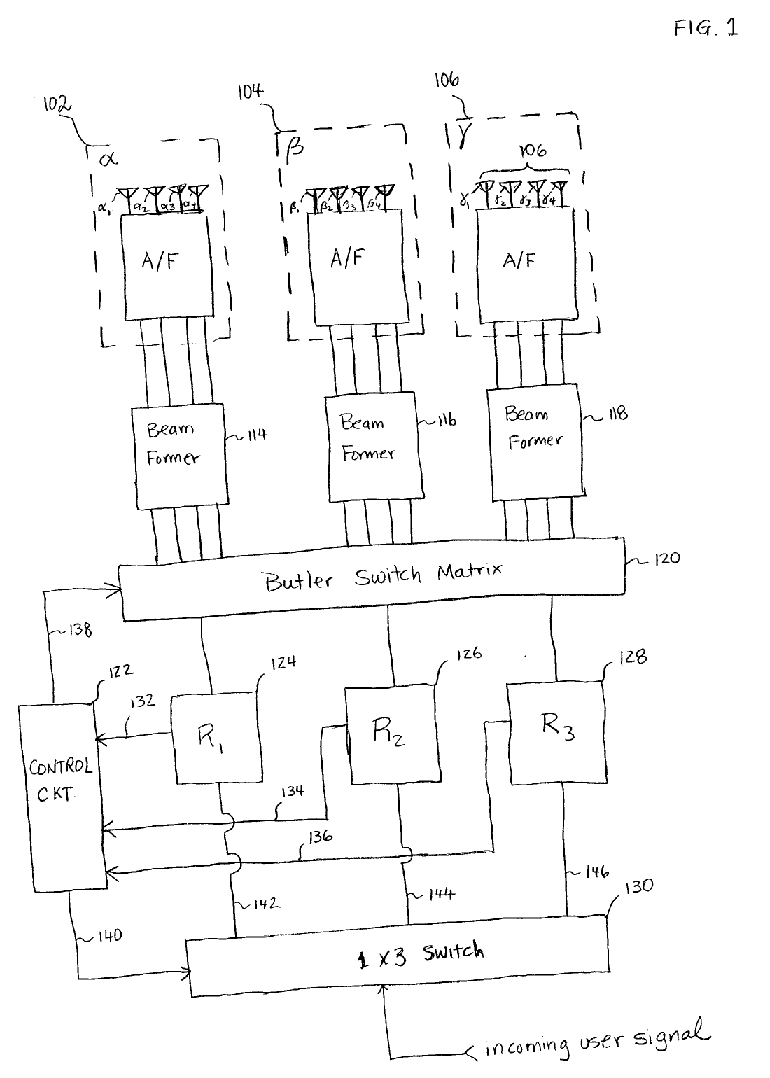

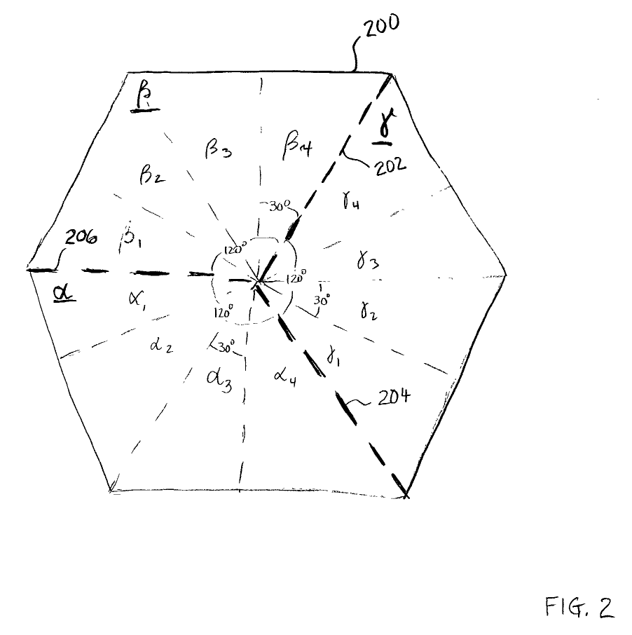

Referring now to FIG. 1, there is shown a radio transmission system that is part of a wireless communication system and used to implement the method and system of the present invention. The cell which the radio system of FIG. 1 is servicing is shown in FIG. 2. Referring momentarily to FIG. 2, cell 200 is shown divided into three sectors, α, β and γ. Sector α is bounded by boundaries 206 and 204; sector β is bounded by boundaries 206 and 202 and sector γ is bounded by boundaries 202 and 204. Each of the sectors is further divided into four subsectors. In particular sector α is divided into subsectors α₁, α₂, α₃ and α₄. Sector β is divided into subsectors β₁, β₂, β₃ and β₄. Sector γ is divided into subsectors γ₁, γ₂, γ₃ and γ₄. Although cell 200 is shown as a hexagon divided into 120° slices and the sectors are further subdivided into 30° slices, an actual cell may have any shape that represents a particular geographical area; the sectors and subsectors of the cell need not be symmetrical as those depicted by FIG. 2.

Referring back to FIG. 1, the radio transmission architecture shows a control circuit 122 coupled to a signal switch 130 and a Butler Switch Matrix 120 via paths 140 and 138 respectively. Three radios, R₁(124), R₂(126) and R₃(128), each has an input coupled to an output of signal switch 130 via paths 142, 144 and 146. The outputs of the radios are coupled to the input of the Butler Switch Matrix 120. For each of the radios, a parameter directly related to user population is monitored by control circuit 122 via paths 132, 134 and 136. The outputs of the Butler Switch matrix 120 are coupled to beam formers 114, 116 and 118 respectively. The output of the beam formers are coupled to antenna systems 102, 104 and 106. Each of the antenna systems comprises Amplifier/Filter (A/F) circuitry and at least one antenna. Antenna system 102, which services sector α of cell 200 (see FIG. 2), is shown having four antennas each of which is labeled with the sub-sector that it is servicing. Similarly, antenna system 104 is servicing sector β and antenna system 106 is servicing sector γ where each of the antennas is labeled with the particular sub-sector that it is servicing. The radios can be implemented with standard analog RF (Radio Frequency) circuitry that performs signal modulation, amplification and filtering. The radios can also be implemented with digital circuitry, digital signal processors, microprocessor circuitry or any combination thereof. Switch 130 is shown coupled to the three radios via paths 142, 144 and 146 respectively. Switch 130 is shown as a 1×3 switch meaning that it has one input and three outputs. Incoming user signals appear at the input of switch 130. Switch 130 can be implemented as a digitally controlled analog switch using any well known switch circuit. A digital signal on path 140 causes switch 130 to route an incoming user signal to one of the three outputs of the switch. Thus, depending on the value of the digital control signal on path 140, the input signal can be routed to any one of the three outputs of switch 130. In general, a 1×K switch can be used where K is equal to 2 or greater. Control circuit 122 can be implemented with digital and/or analog hardware. Control circuit 122 can also be implemented with a microprocessor or a digital signal processor or both. The processors can be under the control of software and/or firmware or both. It will be readily understood by one skilled in the art to which this invention belongs that more than three radios can be used; the system can have standby radios that can be switched into service should all three radios are operating near their ceiling thresholds and incoming users are requesting admission to the system. The standby radios would help reduce dropped calls, i.e., calls that the system cannot handle and thus does not admit the users associated with those calls.

Each of the radios is coupled to Butler Switch matrix 120. Butler switch matrix is a signal switch—for RF signals and other types of analog signals—that has multiple inputs and multiple outputs. Butler switch matrix 120 can be controlled by control signals on path 138 to route any one of its inputs to a plurality of its outputs. The outputs of Butler switch matrix 120 are coupled to beam formers 114, 116 and 118 respectively. Butler switch matrix 120 is shown to have three inputs and 12 outputs where the outputs are arranged into groups of four signal paths. In general an N input, M output signal switch matrix can be used where N and M are integers equal to 1 or more. Each of the signal paths of the output of Butler switch matrix is coupled to a beam former. The beam formers are well known circuits that can process signals for transmission by antennas so as to control the beam width of the antenna signal, the direction of the beam and/or the intensity of the beam. The outputs of the beam formers are applied to antenna systems each of which comprises at least one antenna. The antenna system shown includes Amplifier/Filter (A/F) circuitry

The method and system of the present invention operates as follows: when an incoming user requests admission to the communication system, control circuit 122 generates control signals on paths 140 and 138 based on the calculated average user population of each of the radios and the calculated rate of change of the user population of each of the radios. A radio that (1) has a rate of change of user population that will not cause it to operate above its threshold when it receives the user signal and (2) is operating at or below its threshold (and therefore operating adequately below its capacity), is selected. The control signal on path 140 causes the user's incoming signal to be switched to the selected radio. The control signals on path 138 cause Butler switch matrix 120 to route the output of the selected radio to the antenna that is servicing the subsector in which the user is located. In this manner, incoming users are routed to a radio that can handle such users. In sum, each incoming user is routed to any one of the radios based on a calculated average user population and rate of change of user population of the radios.

The average user population of a radio is calculated by determining the number of users that were serviced by the radio over a defined time period referred to as T. The defined time period is preferably the time elapsed from when a user's incoming signal is switched to a radio to the time that signal is transmitted by a corresponding antenna; this time period is referred to as the processing time. The number of users is determined by measuring one or more parameters that are directly proportional to the user population of the radio. For example, the output power of a radio is directly proportional to the number users being serviced by that radio. Other parameters include the data rate at which the radio is transmitting information and the bandwidth being used by the radio to transmit the information. In other words, one can determine the user population from the data rate of the radio or from the bandwidth of the radio or some other parameter that can be directly related to the user population. However, for the sake of explanation, the parameter being measured by control circuit 122 for each of the radios is the transmit power, P, of each radio. The average number of users is therefore proportional to P. A proportionality factor relating transmitted power to number of users, say k, is obtained from the design of the radio system. Therefore the average number of users is m=kP.

The rate of change of user population is calculated over at least two processing time periods (i.e., 2T) to prevent the system from reacting too quickly to changes in user population. If the rate of change of user population were calculated over one processing time period, the incoming user signal could be routed to a radio that may not be capable to process that signal and therefore jeopardizing the proper operation of that radio. Thus, the rate of change of the user population is designated as

$$\frac{ⅆ m}{ⅆ ( 2 T )} ,$$

i.e., the mathematical derivative of the user population over two processing time periods. Note that in general, the rate of change of the user population can be defined as

$$\frac{ⅆ m}{ⅆ ( LT )}$$

where L is an integer equal to 1 or greater; thus, there can be circumstances where the rate of change is calculated over one, two or any integer number of processing periods. As the population being serviced by each radio varies, the method and system of the present invention updates the threshold assigned to each of the radios. It will be readily understood that for any of the radios, when

$$\frac{ⅆ m}{ⅆ ( 2 T )}$$

is negative, the user population is decreasing and therefore more users can be admitted meaning that the user population threshold can be increased. However when

$$\frac{ⅆ m}{ⅆ ( 2 T )}$$

is positive, the user population is increasing meaning that the population threshold should be lowered to reduce the likelihood that new incoming users signal will be routed to that radio. Accordingly, the method and system of the present invention calculates a weighting coefficient proportional to

$$\frac{ⅆ m}{ⅆ ( 2 T )} .$$

The weighting coefficient is defined as

$$\frac{- T}{[ \frac{ⅆ m}{ⅆ ( 2 T )} ]} .$$

The method and system of the present invention sets an initial user population threshold, mₜ_{ᵢₙ} at an adequate value. The adequate value is arrived at through previous studies and user population patterns of the cell. Any well known algorithm for calculating the initial user population threshold based on population history can be used. The updated user population threshold, mₜ_{_{new}}, is defined as

$${m}_{{t}_{new}} = {m}_{{t}_{in}} \{ 1 + \frac{- T}{[ \frac{ⅆ m}{ⅆ ( 2 T )} ]} \} . \qquad ( 1 )$$

Note that mₜ_{ᵢₙ} does not change, but mₜ_{_{new}} varies as the rate of change of user population varies. As new users are added to a particular radio, the method and system of the present invention determines whether the new population threshold is adequately below a ceiling threshold. The ceiling threshold is a value for user population above which the radio will operate relatively near its capacity. The capacity of a radio is the value of user population above which the radio will not operate properly. The capacity of a radio depends on the particular design parameters of that radio. The ceiling threshold is arbitrarily set by the service provider and can be calculated using historical data for

$$\frac{ⅆ m}{ⅆ ( 2 T )}$$

or other historical data related to user population. The ceiling threshold does not vary as the population varies; it is a value established by the service provider to prevent any of the radios from operating perilously close to their capacity. The ceiling threshold thus provides some cushion to the radios to prevent them from operating at or above their capacity. As is well known, radio circuitry operating at or above their capacity will generate distorted signals.

When the population of a particular radio is relatively very near or is approaching the ceiling threshold and the rate of change of user population is positive, newly arriving users are not routed to that radio until that radio's population and population threshold is adequately below the ceiling threshold. Whether or not a population threshold is adequately below the ceiling threshold is determined in an arbitrary manner by the circuitry and/or algorithm residing in control circuit 122; such an algorithm may or may not rely on historical population data. For any particular radio, as long as the population threshold is adequately below the ceiling threshold and the user population is at or below the population threshold, incoming users can be added. Thus, the method and system of the present invention automatically routes incoming users to the proper radio so as to efficiently use the available radio resources of the system.

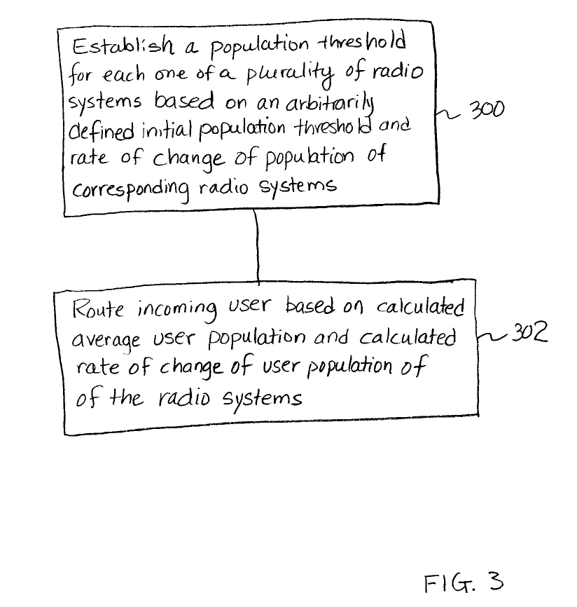

Referring now to FIG. 3, a flow chart of the method of the present invention is depicted. In step 300, an initial population threshold, mₜ_{ᵢₙ}, is established by an algorithm residing in control circuit 122. The population threshold, mₜ_{_{new}}, is then subsequently established as per equation (1) above. Also, a ceiling threshold is arbitrarily established as discussed above. For the sake of explanation of the method of the present invention, the following example is analyzed. Each of the radios has been allocated 10, (P=10) watts of transmission power where each user is allowed to transmit at a power of 100 milliwatts. The capacity of each of the radios is thus 100 users. Note that the proportionality factor, k, is equal to 10 since m=100 and P=10. The system arbitrarily sets a ceiling threshold, m_{c}, of 90 users for all three radios. Initially, each of the radios is assigned a population threshold of 65 users, i.e., mₜ_{ᵢₙ}=65. As users are admitted to the system, certain radios develop higher population than others. All three radios are eligible to receive users because their population thresholds are below the ceiling thresholds. The method of the present invention confirms that a radio's threshold and population are below the ceiling threshold before declaring a radio eligible to process new user signals, i.e., receive new users. The average user population, the rate of change in user population and the population threshold are calculated continually by control circuit 122. Those radios whose population thresholds are relatively very near the ceiling threshold are declared ineligible to receive new users. The method of the present invention arbitrarily determines proximity of a radio's population to the ceiling threshold based on the rate of change of user population for the radio and the current population being serviced by the radio. For the example being discussed a population of 85 may not necessarily be declared too close to the ceiling threshold of 90 especially when the rate of change of the population is negative and is relatively high. For example, the rate of change may be −12 users per 2T where T is the processing period discussed earlier. In another circumstance, a population of 85 users may be deemed close enough to the ceiling threshold to warrant declaring the radio handling the 85 users ineligible. Such a radio, for example, may have a current rate of change of user population of +12 users per 2T meaning that the radio is likely to be saturated with a user population above the ceiling threshold and near the capacity of the radio. The proximity of the current user population to the ceiling threshold can be determined with an algorithm residing in control circuit 122. Note that when all three radios are operating relatively well below the ceiling threshold, incoming users can be randomly routed to the radios or the incoming users can be routed in a round robin fashion or any arbitrary fashion. Continuing with the example, and referring momentarily back to FIGS. 1 and 2, suppose at some point 4 new users in subsector β₂ are requesting admission to the system. Radio 124 has a user population of 75, a population threshold of 80 and a rate of change of −5 users per 2T. Radio 126 has a user population of 86, a population threshold of 91 and a rate of change of +5 users per 2T. Radio 128 has a user population of 85, a population threshold of 87 and a rate of change of −4 users per 2T. After the user population, the population threshold and the rate of change of user population have been calculated, the method of the present invention moves to step 302.

In step 302, the 4 incoming users in subsector β₂ will be routed based on the average user population and rate of change of user population for each of the radios. The method of the present invention will first determine which radios are eligible and then select one or more of the eligible radios to route all or a portion of the new users requesting admission. Eligible radios are those whose current user population is not above the ceiling threshold or whose rate of change of user population will not cause the radio to operate above the ceiling threshold after the user has been routed to such radio. None of the four users will be routed to radio 126 at this point because it has a population threshold above the ceiling threshold and its rate of change indicates that it is fast approaching its capacity. The four users can all be added to either radio 124 or radio 128 since both have decreasing user populations. However, radio 124 may be a better candidate since it has a lower population and population threshold than radio 128. In cases, where the number of incoming users cannot be added to one radio, portions of the users are routed to the eligible radios. The size of the portions again depends on the current population and rate of change of population of the radios. For example suppose 10 users instead of 4 users were requesting admission to the system. The method of the present invention could route 7 users to radio 124 and 3 users to radio 128. More users are routed to radio 124 because based on its population and rate of change of population, it can handle more users. Any well known apportionment technique can be used to decide exactly how many users are routed to radio 124 versus radio 128. Another technique for selecting (from the set of eligible radios) the radio to which the incoming are to be routed is to select the radio with the lowest current user population or the radio having the lowest rate of change of user population or the radio whose user population combined with the rate of change of user population renders the lowest value. The combination of the user population and rate of change of user population can simply be the product (i.e., multiplication) of the two values or some other mathematical combination of the two values. After users are routed to one or more radios, the updated threshold, mₜ_{_{new}}, is calculated. Note that the updated threshold is calculated based on the initial threshold and the rate of change of user population as shown in equation (1) supra.

We claim:

1. A method for processing incoming radio signals in a wireless communication system, the method comprising the step of:
routing the incoming signals to at least one of a plurality of radio equipment based on user population and rate of change of user population of the plurality of the radio equipment.

2. The method of claim 1 where the step of routing the incoming signals comprises:
establishing a ceiling threshold for each of the plurality of radio equipment;
establishing a population threshold for each of the plurality of the radio equipment; and
calculating an average user population and rate of change of user population for each of the plurality of the radio equipment where the rate of change of user population calculation is done over at least two processing periods.

3. The method of claim 2 further comprising selecting at least one radio equipment to which the incoming signals are to be routed where the at least one selected radio has a population threshold that is adequately below the ceiling threshold and a user population that is below the population threshold.

4. The method of claim 3 where the step of selecting at least one radio equipment comprising determining whether the at least one radio equipment is an eligible equipment based on the population threshold of the at least one radio equipment and the rate of change of the at least one radio equipment.

5. The method of claim 2 further comprising the step of updating the population threshold based on the rate of change of user population.

6. A radio transmission system for a wireless communication system, the system comprising:
control circuitry that routes incoming user signals to at least one radio equipment based on the at least one radio equipment's user population and rate of change of user population calculated by the at least one radio equipment.

7. The radio transmission system of claim 6 further comprising:
an input switch coupled to the control circuitry;
at least one radio coupled to the control circuitry, the at least one radio is further coupled to an output of the input switch;
a Butler switch coupled to the control circuitry, the Butler switch has at least one input coupled to at least one radio output and the Butler switch has at least one output coupled to at least one antenna.

8. The radio transmission of claim 7 where the input switch is a 1×K switch and the Butler switch is an N×M Butler switch matrix where K, N and M are integers equal to 1 or greater.
